(19) United States
(12) Patent Application Publication
(10) Pub. No.: US 2011/0294565 A1
(43) Pub. Date: Dec. 1, 2011

(54) CONSOLIDATED GAME FLOW FOR LEARNING PRODUCTIVITY APPLICATIONS

(75) Inventors: JENNIFER P. MICHELSTEIN, Kirkland, WA (US); Jonas Helin, Kirkland, WA (US); Abhishek Agrawal, Seattle, WA (US); Steve Courtney, Redmond, WA (US); David Edery, Kirkland, WA (US); Chad Waldman, Seattle, WA (US)

(73) Assignee: MICROSOFT CORPORATION, Redmond, WA (US)

(21) Appl. No.: 13/111,192

(22) Filed: May 19, 2011

Related U.S. Application Data
(63) Continuation-in-part of application No. 12/790,472, filed on May 28, 2010.

(51) Int. Cl. A63F 13/00

(52) U.S. Cl. 463/23

(57) ABSTRACT

Consolidated game flow for a plurality of different productivity applications is provided by a challenge director which may be local to a computing device or accessible via a remote network server. A consolidated game board display output of the challenge director at the computing device may encourage learning features of different productivity applications, for example, based on achieving at least one challenge for a feature that is of a different productivity application than one currently utilized by a user. The challenge director may launch a productivity application associated with a challenge from a version of the productivity application currently available at the computing device at the beginning of challenge play. An overall theme of the consolidated game board display may link a plurality of levels of play to one another with individual related sub-themes for each skill level of game play.

### CROSS REFERENCE TO RELATED APPLICATIONS

This application is a continuation-in-part of U.S. application Ser. No. 12/790,472 filed May 28, 2010, entitled “Using Game Play Elements to Motivate Learning,” of Jennifer Michelstein et al., and is related by subject matter to U.S. application Ser. No. ______, file concurrently herewith of Jennifer Michelstein et al., entitled “Animation for a Productivity Applications Learning Tool Game,” both applications being incorporated by reference herein as to their entire contents.

### BACKGROUND

Modern productivity applications enable users to perform a large number of commands, for example, during the preparation of documents or within data files. For example, a word processor productivity application can enable a user to manipulate the appearance of text, insert tables, insert footnotes, create tables of content, add page numbers, review changes, and so on. In another example, a spreadsheet application can enable a user to select styles for cells, create and insert charts, set the layout for spreadsheet pages, and so on. In yet another example, a presentation application may enable a user to combine tables, text, graphics and image data into an integrated presentation, and so on. In yet another example, a database application can enable a user to enter data into a database linked to other data, for example, in a database tree of a relational database, and so on.

Other productivity applications may be provided such as for note-taking, browsing the Web, preparing formal drawings, managing personal calendars and communications and the like. Moreover, many such productivity applications provide for consolidation and/or inter for example, such that text or graphics or data from one productivity application may be utilized in another different productivity application. For example, a text passage from a document prepared with a word processor application may be copied to a document prepared in one of a spreadsheet application, a presentation application or a drawing application.

Traditionally, productivity applications have used menu systems to enable users to select and perform commands on documents. A menu system comprises a set of menus. Each of the menus contains one or more menu items. Selection of a menu item can cause a productivity application to perform a command on a document, open an interface that provides the user with more options such as, for example, a “help” option, or perform some other action or provide an additional feature. Menu systems can be beneficial because menu systems frequently do not occupy large amounts of onscreen space. However, users may find it difficult to find commands because a desired menu item associated with those commands may be located in a long list of menu items.

In addition to menu systems, some productivity applications provide toolbars. A toolbar comprises a fixed set of selectable icons associated with commands. The icons can graphically suggest the effect of performing the commands associated with the icons. Selection of an icon can cause the productivity application to perform some command. Toolbars can be beneficial because the graphical icons can help users more quickly and easily understand the associated commands. Furthermore, toolbars can be beneficial because toolbars can remain onscreen and thus can be selected with a single click. Labeling the icons with text can cause each icon to become so large that the toolbar occupies an unacceptable amount of onscreen space.

A ribbon-shaped user interface is known that may include a set of toolbars placed on tabs in a tab bar. The tab bar can be rectangular in shape and labeled. Ribbon-shaped user interfaces can have the benefits of toolbars in that users can see and select graphical icons to perform commands. Furthermore, ribbon-shaped user interfaces can have some of the benefits of menu systems because not all of the icons are onscreen at once. As a result, a ribbon-shaped user interface can occupy less onscreen space on a given screen than a toolbar because only one tab is open for display at a time.

A computing device displays a user interface containing a ribbon-shaped user interface. The ribbon-shaped user interface may contain multiple tabs. Each of the tabs may contain multiple controls, features or commands. Furthermore, the computing device may display a challenge of a learning tool game and a tab visualization control in the user interface. The challenge of the learning tool game may offer a user the opportunity to learn a command or feature of an associated productivity application. A challenge may instruct a user of the computing device to perform a task, the user accessing the challenge by one of a menu, a toolbar, a ribbon-shaped or other user interface of the productivity application or as a stand alone challenge director interface. The challenge may not instruct the user how to perform the task. If the user does not know how to perform the task using the ribbon-shaped user interface, the user may select a tab visualization control. In response to receiving selection of the tab visualization control, the computing device may display a popup window in the user interface. The popup window may initially contain an image of an initial portion of a given tab in the ribbon-shaped user interface. The image of the given tab may scroll within the popup window such that a target control in the given tab is visible within the popup window. The user may need to use the target control to perform the task. Scrolling the image of the given tab within the popup window can help the user learn the location of the target control within the tab.

A known learning tool provides such a user interface through which a user may learn the use of commands of a productivity application, and, in so doing, obtain a score and compete against others in a social network. Michelstein et al, U.S. patent application Ser. No. 12/943,668 filed Nov. 10, 2010, entitled “Learning Tool for a Ribbon-Shaped User Interface,” describes such a learning tool user interface and is incorporated by reference as to its entire contents. The learning tool may be considered a game. Some individuals even play a game to a point where they vigorously compete against others. To become proficient at a game, a user may also learn a productivity application or how to interwork between or among different productivity applications. The learning game tool may be associated with and integrally a part of each productivity application such that a user may learn a feature or command of a given productivity application through challenges presented in the learning tool game associated with a utilized productivity application.

Given the foregoing, what is needed are systems, methods and computer program products for providing a consolidated game flow interface in a productivity application of a suite of different productivity applications for accessing a consolidated game board for a learning tool game having a consolidated game flow wherein a user may select to display the consolidated game board for a plurality of different productivity applications and play challenges for and so learn the plurality of different productivity applications, for example, of a suite of productivity applications.

### SUMMARY

This summary is provided to introduce a selection of concepts. These concepts are further described below in the Detailed Description. This summary is not intended to identify key features or essential features of the claimed subject matter, nor is this summary intended as an aid in determining the scope of the claimed subject matter.

A consolidated game flow for learning productivity applications facilitates not only learning a single productivity application, but also encourages a user to learn how a given productivity application may interwork with different productivity applications as well as features of other productivity applications from the same consolidated game board. That is, challenges of a game for learning one productivity application may encourage a user to learn another, different productivity application feature or may launch a different productivity application than a currently utilized productivity application in a ribbon-based or other form of productivity application environment. A user may access a consolidated game flow game board via a selected portion of a productivity application user interface representing a level of play of a learning tool game. For example, a challenge director interface may comprise a portion of a ribbon, toolbar, may comprise a drop-down menu item or comprise another user interface. The challenge director interface may comprise a stand-alone application of the user's computer device. In one embodiment, the challenge director interface of the productivity application provides a visual indication of skill level of play and accumulated point score for all challenges played in the learning tool game. Moreover, in order to move from level to level of learning tool game play, one may be required to earn a sufficient score in each of a plurality of different productivity applications to encourage a user to learn more than one productivity application.

According to one embodiment, a challenge director may access a version of a productivity application to play a challenge for that productivity application version presently available on a user's computing device. According to an alternative embodiment, a challenge director may control a network server to download a test version of a productivity application that the user does not currently have on their computing device, just to play a challenge. In this embodiment and from playing the challenge, the user may be encouraged to learn or obtain a productivity application or version thereof that the user presently does not presently have. In one embodiment, a user of a computing device obtains access to a consolidated game board user interface, for example, by actuating a challenge director interface as a stand alone application.

In an embodiment, the challenge director interface may be a stand alone application implemented on the user's computing device. In another embodiment, the challenge director interface may be actuated by a user inputting a selection from one of a menu, a toolbar, a ribbon or other interface of the challenge director interface of the productivity application. In either embodiment, the challenge director interface may store and display a skill level of play and an accumulated score. When actuated, the challenge director interface connects a user to or locally actuates a challenge director. The challenge director may be a program module which actuates a display of a consolidated learning tool game board for the skill level of play personal to a user.

In an embodiment, an overall theme such as time travel may be provided with a consolidated learning tool game board user interface that is then actuated for display by the challenge director at a user's computing device in place of a productivity application display screen. Thus, the consolidated game board may take a user away from the productivity application the user is currently utilizing and place them in an imaginary world. The learning tool game play of the consolidated game board may be controlled by the challenge director module which may be downloaded to a user's computing device or accessed from a network server.

One aspect of the embodiment is that a user (or player) may have an accompanying cartoon character such as a paper clip named “Clippy” during play of the consolidated learning game. Different skill levels of may represent different imaginary worlds or sub-themes within the overall theme of time travel, such as THE 1960's, “ANCIENT EGYPT” or THE MIDDLE AGES. The general theme of time travel and sub-theme for a level such as THE MIDDLE AGES, for example, are exemplary only. In an alternative embodiment, for example, the overall theme ma be space travel and the levels of play represented by THE MOON, MARS, THE MILKY WAY and the like.

In a further embodiment, the consolidated game flow game board may be provided central to a plurality of related productivity applications by the challenge director. In other words, a common game board may be shared among all the different productivity applications of a suite of productivity applications. The consolidated game board for a given skill level of play may display a plurality of challenges in the form of images related to the sub-theme that a user may select and play. A user playing a challenge from a consolidated game board may learn the use of the ribbon, toolbar, menu or other user interface or command system of one or more related, but different, productivity applications of the suite from the same consolidated game board. For example, an interactive screen portion may provide image portions of the game board display representing the challenges such as a sphinx of the ANCIENT EGYPT game board may display an indicator associated with the sphinx as to whether a challenge associated with the sphinx has been previously selected and completed. A further indicator may also be provided proximate to the sphinx image as to whether the challenge has been successfully played using a minimum number of hints such that bonus points may be awarded. In other portions of the consolidated game board display, there may indicators of skill level achieved by the user having a sub-theme, such as level 2 for “Ancient Egypt” within the overall theme of time travel and a total number of points achieved for challenges played thus far by a user to achieve a total, predetermined score level, among other features of the consolidated game board.

In one embodiment, clickable, hoverable or otherwise selectable images, for example, may be provided, within the consolidated game board display of a sub-theme image representing a level of game play, such as a sphinx of the Ancient Egypt sub-theme having further icons or symbols representing challenge selection, completion and bonus points. For example, an image of a Sphinx from the Ancient Egypt sub-theme game board may display different symbols or icons, such as a checkmark and/or a star and/or a plus sign, within a given challenge. A checkmark may indicate successful selection and a star accomplishment of the challenge respectively. The plus sign may indicate bonus point awards.

In an embodiment of a consolidated game board and during game play, a banner may be displayed on the game board indicating the productivity application (or applications) that the challenge is associated with, identification of a command or feature of the productivity application learned, a fun phrase such as “Clippy breaks the Sphinx” indicating, for example, the success of the cartoon game character with respect to a particular challenge and an associated score and any bonus points achieved by winning the challenge.

These and other features of a system and method for consolidating game flow for learning a plurality of different productivity applications will become clear from the drawings and detailed description thereof which follows their brief description.

### BRIEF DESCRIPTION OF THE DRAWINGS

The features and advantages of the present invention will become more apparent from the detailed description set forth below when taken in conjunction with the drawings in which like reference numbers indicate identical or functionally similar elements.

FIG. 1 illustrates a computer architecture for a computer having a challenge director interface adapted for consolidated game flow for learning a plurality of different productivity applications.

FIG. 2 shows an exemplary process of a challenge director of FIG. 1 for providing a consolidated learning system game interface for consolidating learning a plurality of different productivity applications.

FIG. 3 provides a sample display screen portion, for example of a ribbon interface of a computing device according to FIG. 1 for accessing a challenge director process according to FIG. 2.

FIG. 4 provides an example of a consolidated learning tool game board actuated for display on the computing device of FIG. 1 showing an overall theme, a sub-theme, a present level of game play, a user score, a fun phrase, a plurality of icons and a banner portion for consolidating a user's learning a plurality of different productivity applications in accordance with the computer architecture of FIG. 1 and the exemplary learning process of a challenge director of FIG. 2.

FIG. 4 provide several examples of different consolidated game boards and respective different levels of play representing different sub-themes within an overall theme wherein FIG. 5A provides an exemplary consolidated game skill level 1 interface having a sub-theme of the Middle Ages of a time travel theme; FIG. 5B provides an exemplary consolidated game skill level 2 interface having a sub-theme of Ancient Egypt; FIG. 5C provides an exemplary consolidated game skill level 3 interface having a sub-theme of “the 1960's;” FIG. 5D provides an exemplary consolidated game skill level 4 interface having a sub-theme of Ancient Greece; FIG. 5E provides an exemplary consolidated game skill level 5 interface having a sub-theme of The Renaissance; and FIG. 5F provides an exemplary consolidated game skill level 6 interface having a sub-theme of The Future.

### DETAILED DESCRIPTION

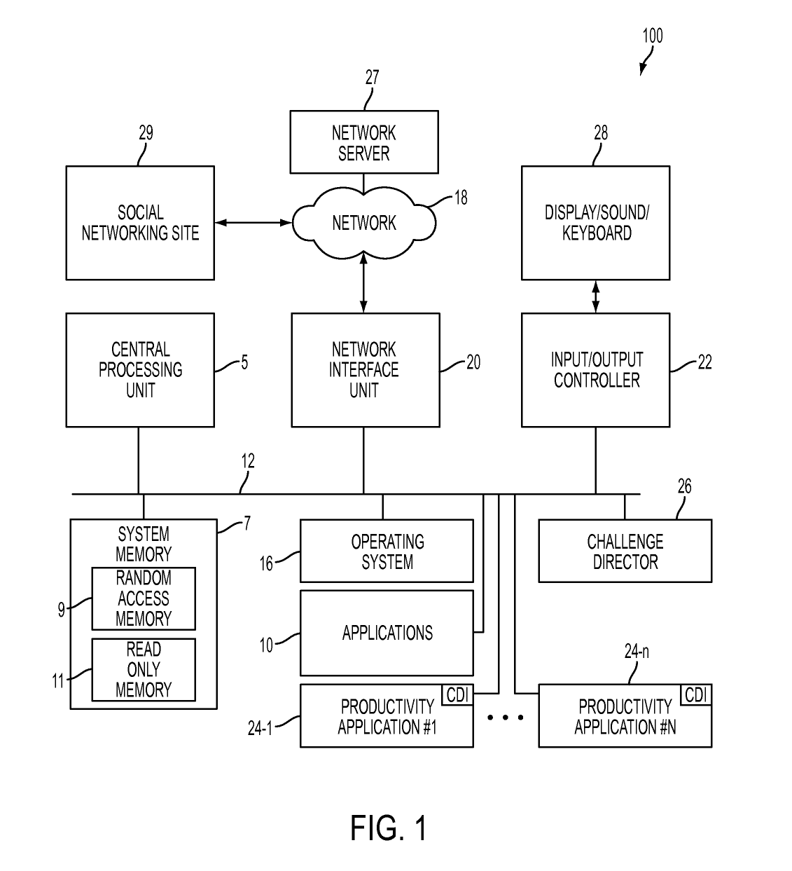

Referring now to the drawings, various embodiments will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. According to FIG. 1, a challenge director 26 comprises a program module that may be implemented on a computing device 100 or provided remotely as accessible by computing device 100 via a network server 27. As will be further described herein, a challenge director 26 may be accessed via a challenge director interface (CM) of a productivity application 24-1 to 24-n which are intended to represent different productivity applications of a suite of such productivity applications. In an alternative embodiment, a challenge director interface may be actuated as a stand alone application on computing device 100.

Other computer system configurations may also be used, including multiprocessor systems, microprocessor-based or programmable consumer electronics, minicomputers, mainframe computers, and the like. Distributed computing environments may also be used where tasks are performed by remote processing devices that are linked through a communications network 18. In a distributed computing environment, program modules such as those comprising challenge director 26 may be located in both local and remote memory storage devices, for example, of computing device 100 or network server 27.

Referring now to FIG. 1, an illustrative computer architecture for a computing device 100 utilized in the various embodiments will be described. In various embodiments, computing device 100 or network server 27 may be configured as a desktop computer, a laptop computer, a personal digital assistant (PDA), another form of intelligent communication device, a tablet, a server, or other mobile computer, a commercially-available intelligent communications device, combination thereof or the like. Computing device 100, as may network server 27, may include a central processing unit 5 (‘CPU’) specially programmed to permit play of a consolidated learning tool game for a plurality of productivity applications. The challenge director 26 of one of computing device 100 or network server 27 may be accessed via a productivity application 24 challenge director interface (CDI) in one embodiment. A computing device 100 or server 27 may further comprise a system memory 7, including a random access memory 9 (“RAM”) and a read-only memory (“ROM”) 11, and a system bus 12 for coupling the memory to the CPU 5. The challenge director interface of a productivity application may appear on one of a ribbon, a toolbar, as a menu item or other user interface and so may comprise a portion of a productivity application display screen via display 28. In an alternative embodiment, a challenge director interface may be actuated as a stand alone application on computing device 100. The challenge director interface may be a program module configured to provide a display of skill level of play of a consolidated learning tool game and an associated accumulated score and store the accumulated score and skill level for a given user computing device 100 memory. A basic input/output system (BIOS) containing the basic routines that help to transfer information between elements within the computing device 100 or server 27, such as during startup, is stored in the ROM 11.

The computing device 100 further may include a mass storage device (not shown) for storing an operating system 16 such as the Microsoft Windows® operating system, different productivity application programs 24-1 through 24-n for, for example, word processing, spreadsheet preparation, drawing preparation, presentation preparation, collecting documents and other media together and the like, each productivity application having a challenge director interface (CDI) to the challenge director 26 or, according to an alternative embodiment, the challenge director interface being a stand alone application of computing device 100. The challenge director 26, as described above, may be accessed from a server and downloaded to computing device 100 of an individual user or be provided for access by computing device 100 from network server 27 where the server 27 is connected to computing device 100 via a network interface unit 20 and network 18. Challenge director 26 may be a program module that communicates with and controls a consolidated game interface or game board for play of challenges for learning a plurality of different productivity application commands, and coordinated use of other program modules, such as features of resident versions of productivity applications 24 on computing device 100 as will be described in greater detail below. In an alternative embodiment, challenge director 26 may launch a test version of a productivity application for playing a challenge associated with a given productivity application challenge, for example, from network server 27 or from another network server connected to network 18 where the test version is not presently installed on the computing device when a challenge is selected. Rather, as will be further described herein, in this embodiment, the test version of the productivity application may begin with the challenge. Also, challenge director 26 may be also be launched from a network server 27 when called by the challenge director interface.

The mass storage device may be connected to the CPU 5 through a mass storage controller (not shown) connected to the bus 12. The mass storage device and its associated computer-readable media provide non-volatile storage for the computing device 100. Although the description of computer-readable media contained herein refers to a mass storage device, such as a hard disk or CD-ROM drive, the computer-readable media can be any available media that can be accessed by the computing device 100. Challenge director 26 may further be provided by means of such computer readable media.

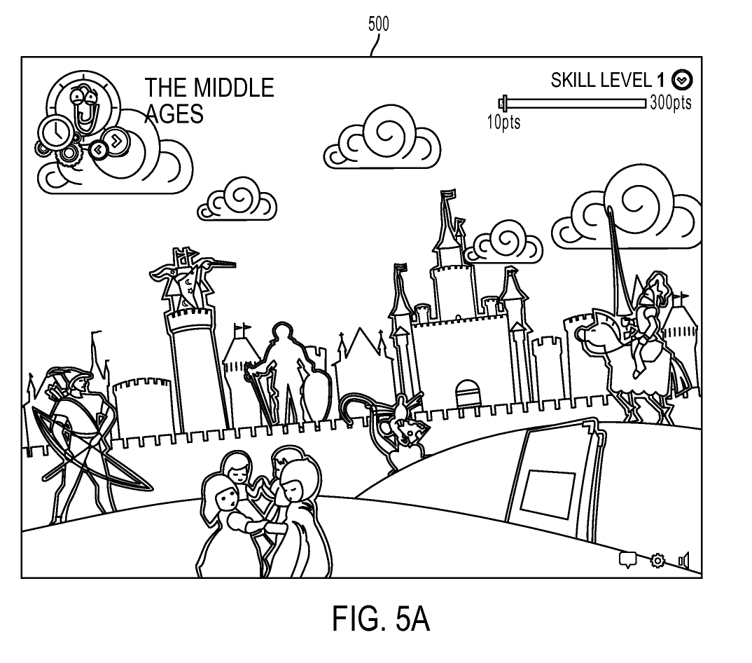

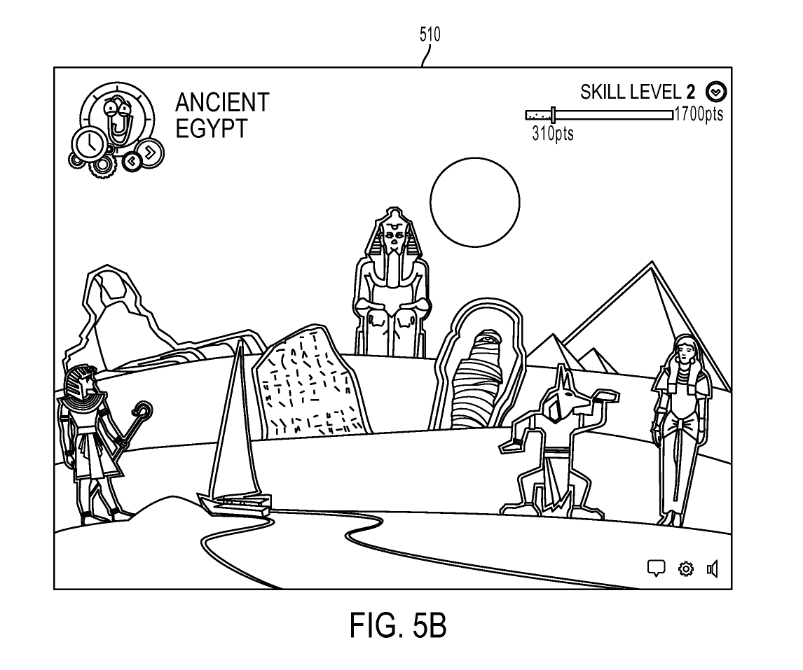

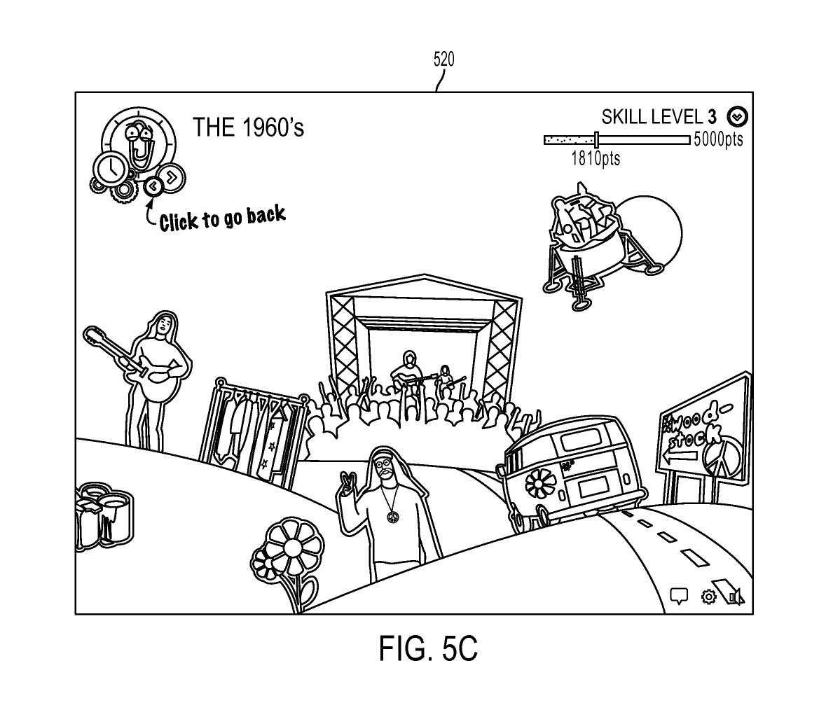

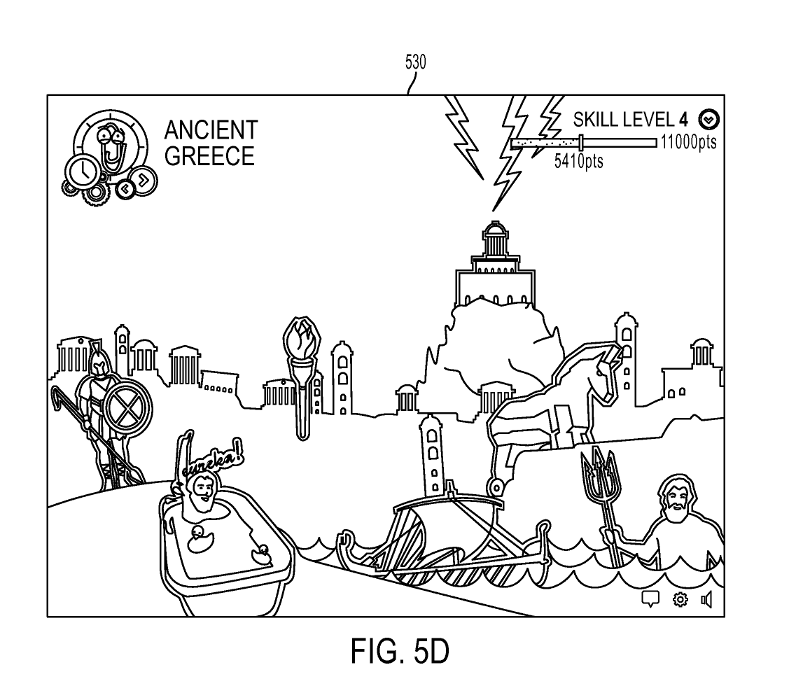

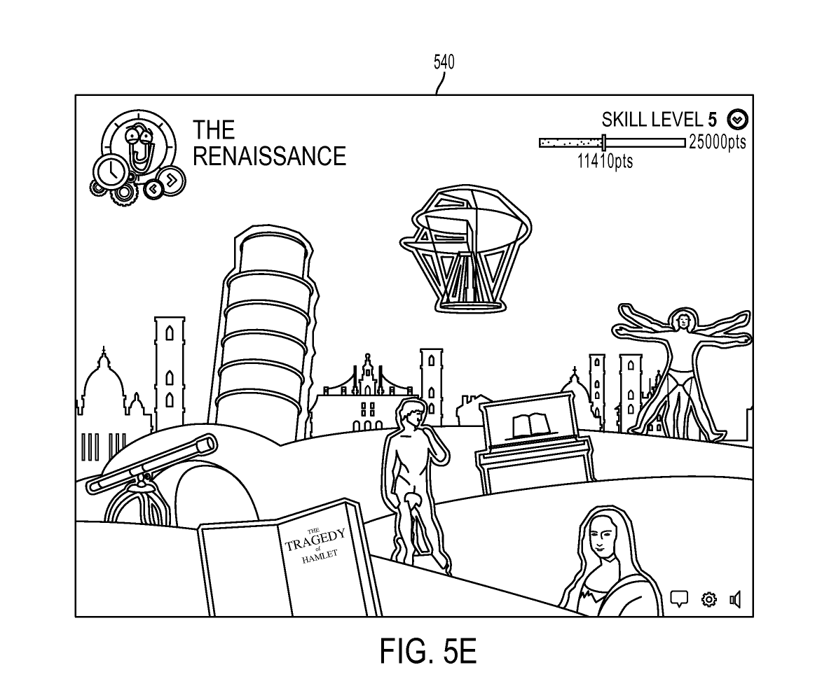

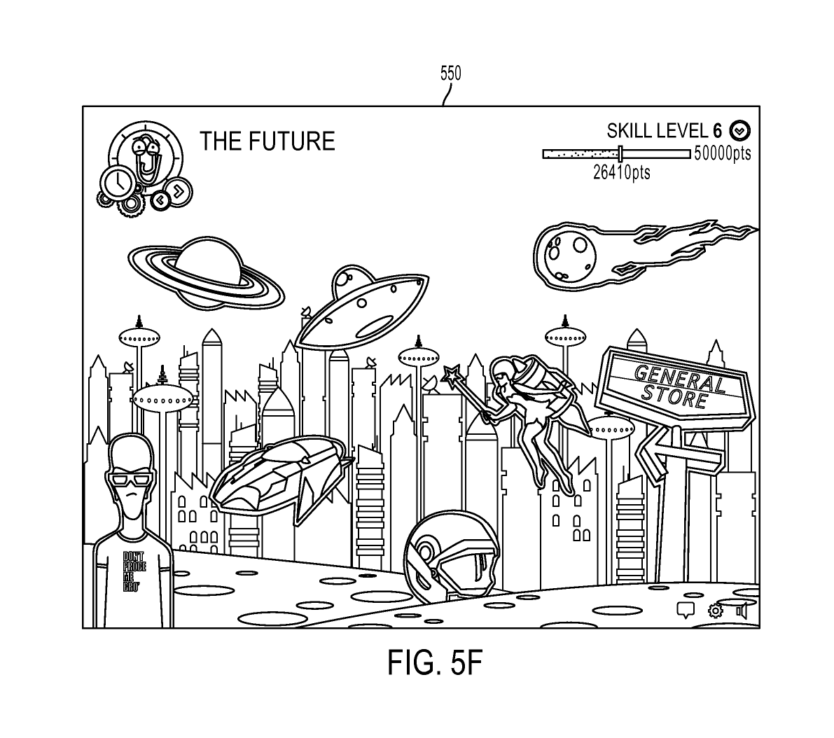

The term computer readable media as used herein may include computer storage media. Computer storage media may include volatile and nonvolatile, removable and non-removable media implemented in any method or technology for storage of information, such as computer readable instructions, data structures, program modules, or other data. System memory 7, removable storage and non-removable storage are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 100. Any such computer storage media may be part of device 100. Computing device 100 may also have input device(s) 28 such as a keyboard, a mouse, a pen, a sound input device, a joystick or equivalent, a touch input device, etc. Output device(s) 28 such as a display, speakers, a printer, etc. may also be included. A display of a consolidated game flow board of output device 28 and provided by challenge director 26 may conform to an overall theme for learning tool game play, such as time travel, as will be further described herein with reference to FIGS. 4 and 5. The aforementioned output devices are examples and others may be used, for example, an interactive touch screen tablet which may simultaneously provide input and an output display.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

According to various embodiments, computing device 100 operates in a networked environment using logical connections to remote computers or servers 27 through a network 18, such as the Internet. As briefly explained above, a challenge director 26 may be hosted on a server 27 and be accessed from computing device 100 via a challenge director interface of a productivity application 24. The computing device 100 may connect to the network cloud 18 and to network server 27 through a network interface unit 20 connected to a bus 12. The network connection may be wireless and/or wired. The network interface unit 20 may also be utilized to connect to other types of networks and remote computer systems.

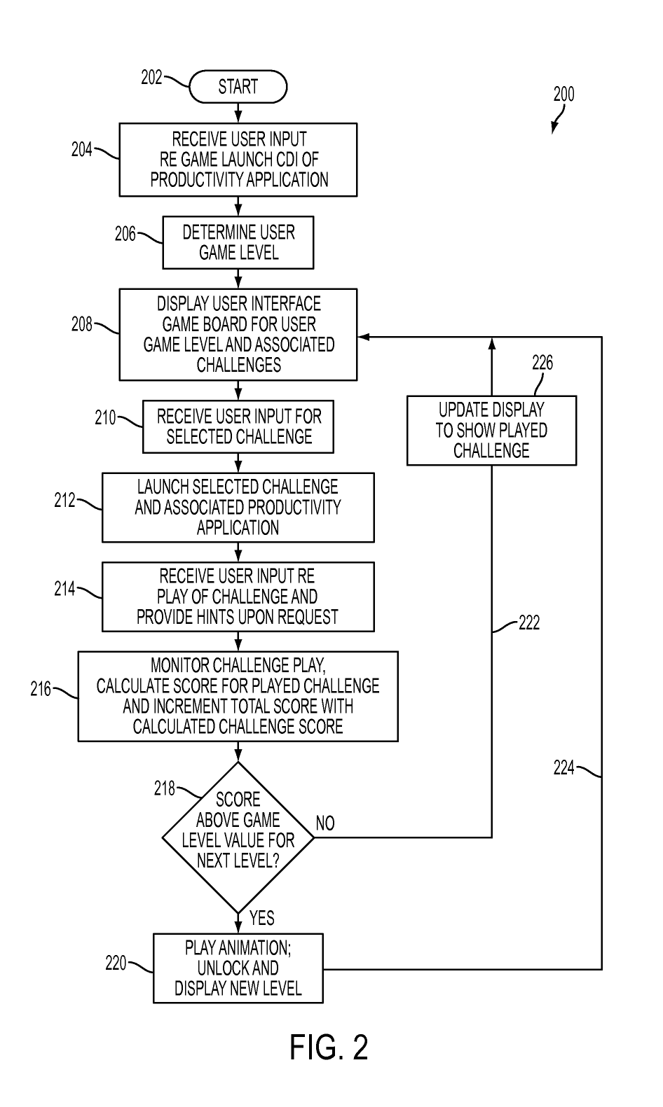

The computing device 100 may also include an input/output controller 22 for receiving and processing input from a number of other devices, including a keyboard, mouse, or electronic stylus (not shown in FIG. 1). Similarly, an input/output controller 22 may provide output to a display screen that includes a user interface such as a display screen which in one embodiment may display a challenge director interface (CDI) of a productivity application 24, or a consolidated game board per one of FIGS. 4 and 5, a printer, or other type of input/output device 28. User interface (UI) 28 is designed to provide a user with a visual way to interact with a productivity application 24 or program module thereof such as a challenge director interface or a stand alone challenge director interface. The CDI may interface with a challenge director 26 that incorporates consolidated game play elements for learning features of a productivity application. As will be described with reference to a process of consolidating game flow as depicted in FIG. 2, a user of computing device 100 may interact with other functionality of other different productivity applications 24 that may be installed on computing device 100 via a game board of FIG. 4 or 5 for consolidating game flow than a productivity application currently being used by a user. Challenge director 26 actuates a version of a productivity application 24 currently installed on the user's computing device 100. In one embodiment, challenges and associated test versions of productivity applications 24 may be remotely downloaded from a network server 27 and started together to play associated challenges.

As mentioned briefly above, a number of program modules and data files may be stored in a mass storage device (not shown) and a RAM 9 of the computing device 100, including an operating system 16 suitable for controlling the operation of a networked computer, such as the WINDOWS 7® operating system from MICROSOFT CORPORATION of Redmond, Wash. The mass storage device and RAM 9 of computing device 100 may also store one or more program modules, for example, a challenge director interface which may appear in a particular portion of a screen of a selected productivity application 24. The challenge director interface may be periodically refreshed at computing device 100 by downloading a new interface from network 18 and server 27 connected to the network cloud 18. In particular, the mass storage device and the RAM 9 of computing device 100 may store one or more different productivity application programs 24-1 to 24-n or modules thereof with each having a challenge director interface (CM).

One of the productivity applications 24 may be one selected from a suite of such applications, i.e., one of the MICROSOFT OFFICE® programs. For example, a word processing productivity application 24 may comprise related features and menu, toolbar, ribbon or related user interface or control structure to a presentation productivity application or to a spreadsheet productivity application, and so on. Through these control structures, a challenge director interface may be provided to challenge director 26. In one embodiment, a challenge director interface comprises a predetermined portion of a ribbon of a productivity application 24 display screen for ease of access or, in an alternative embodiment, may comprise a stand alone application.

Generally, productivity application 24 is one of a suite of productivity applications that a user may utilize in order to complete a task, such as authoring a document in a word-processing program, programming a feature, authoring a spreadsheet, and the like. Productivity application 24 may be an application such as a word-processing program, a presentation program, a spreadsheet program, a database program, a programming environment, and the like. Challenge director 26 may be configured to incorporate elements of learning tool game play into and among productivity applications 24 to assist in motivating users to learn how to use features of different productivity applications. One productivity application may share similar features or provide an encouragement to learn many related features of different productivity applications, for example, by outputting an integrated cumulative score for all productivity application challenges played via a challenge director 26 consolidated game board. For example, the elements of game play that may be incorporated into a consolidated learning game tool application may include items such as usage statistics, scores, levels, challenges, achievements, competition, and the like.

Challenge director 26, once accessed via challenge director interface (CDI), may be a locally or remotely accessible program module that may be configured to track the usage of the features within and among the productivity applications by a user. Challenge director 26 may provide a user with feedback relating to the usage of features of productivity applications 24 as well as to provide recommendations on what features to learn next.

Moreover, even if a user may have an older version of a word processing productivity application stored on computing device 100, the user may temporarily obtain a newer test version of the word processing productivity application or a test version of a different productivity application that may be launched by challenge director 26 and associated with game play of a challenge, for example, so that that user may play a challenge related to the newer version. The user may thus learn related features and commands or may be encouraged to acquire a different related productivity application or the latest version of a productivity application 24. For example, a user or player may be encouraged to obtain a drawing productivity application as they prepare a document requiring drawings using their word processing productivity application by being presented with a related challenge by challenge director 26.

Recommendations for challenges may be based on what features the user has already learned in a given productivity application by completing challenges or from measuring proficiency during their use of the productivity application, what features are related in other productivity applications and/or based on what features the user's peers are using in a social network 29. Moreover, in order to move from one level to a next, a learning tool game may require a predetermined level of proficiency in more than one productivity application 24 to advance to the next level.

Challenge director 26 may also be configured to link help content that is associated with a productivity application for a given challenge with the features/commands that are currently being used by the user in a challenge such that the help content for the feature that is currently being used is available to the user with a single selection. The help content may be considered hints to complete a challenge. Challenge director 26 may be configured to incorporate the use of a social networking site 29 such that a user's peers may be obtained to engage in active competition and to provide updates to the user and the user's peers as to accomplishments using one or more features of the productivity applications 24 learned and challenges played.

According to an embodiment, a consolidated game board such as one depicted in one of FIG. 4 or 5 may be provided that allows the user to see how they are performing both individually as well as how they are performing relative to other users of their peer group (not shown). For example, a group may be a work group, a set of designated friends, friends from one or more social networking sites 29, users who have a similar work title, users in the same profession, and the like. In this way, a user may compare their learning tool game scores, levels and learning experience to other similarly situated users. Scores and accomplishments may be delivered to other users automatically and/or manually. For example, a user's friends on a social networking site 29 may be notified under control of challenge director 26 when a user achieves a certain number of points and/or an accomplishment in one of the productivity applications or the suite of productivity applications 24 as a whole. A user's wall on the social networking site 29 may also be updated with messages indicating the user's progress in the productivity application 24 and/or the suite of productivity applications 24.

Challenge director 26 may allow a user to learn about features that may be useful to them by actuating versions of productivity applications 24 currently installed on computing device 100 to play challenges. The user of computing device 100 may not be aware of a given feature since the user may not be currently using the most current version of the productivity application 24 or a related feature of a related productivity application of potential interest (such as a drawing productivity application permitting the preparation of drawings for inclusion in a document being prepared using a word processing productivity application). As will be further described herein, if a feature or command to be learned by a user is not available locally at computing device 100, the challenge director 26, for example, from network server 27 may provide the user with temporary access to a productivity application test version associated with an offered challenge so that the user may play the challenge for the new version.

Display 28 of computing device 100 may be configured to provide the user with a visual display of a challenge director interface located at a portion of a display screen of a productivity application 24 currently being utilized. When the challenge director interface is actuated, a consolidated challenge game board according to one of FIG. 4 or 5 at a determined level of game play is presented to the user. The challenge director 26 recalls or retrieves from the challenge director interface the user of the productivity application, what level of game play the user has reached and so provides an appropriate game board for the determined level of learning tool game play and associated accumulated score.

Different computing devices 100 may be used by the same user when performing challenges and interacting with a productivity application 24. As a result, a certain user may accumulate points on one or more different computers with the same user name. A data store of challenge director 26 may be configured to provide challenge director 26 with the most current score information for a user such that points obtained across different computer systems by the user may be combined to create a single score that incorporates all of the points of the different computing systems for all the challenges played for many different productivity applications. This score information may be obtained in different ways. The accumulated score may be forwarded by challenge director 26 to a challenge director interface played for a computing device 100 currently utilized. For example, the globally stored score information may be obtained from challenge director 26 when a user logs onto a system. When the user logs onto the system, the most current score information may be obtained and used to update the globally stored score information with the locally stored information either at the computing device 100 or a network server 27. Upon logging onto the system, the system may determine that the points on the local system for a given user do not match the globally stored information and so retrieve the latest skill level and score originating from utilized computing devices 100 via challenge director 26.

According to one embodiment, a social network identifier may be used to uniquely identify the user within a consolidated game flow database and obtain score information for that user. The points stored locally on the computing device 100 may be compared to the globally obtained scores and a union of the points from all challenges played on all computing devices 100 may be used to update the score and level of play that the user has achieved.

Referring now to FIG. 2, there is shown an illustrative process 200 for a challenge director module 26 of computing device 100 or remote network server 27 of FIG. 1 employing game elements to motivate learning within and among different productivity applications 24.

FIG. 2 provides an illustrative process 200 for employing game elements to motivate learning features commands of a suite of productivity applications via a consolidated game flow board according to one of 4 and 5. When reading the discussion of the routines of process 200 presented in FIG. 2, it should be appreciated that the logical operations of various embodiments are implemented: (1) as a sequence of computer-implemented acts or program modules running on a computing system; and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

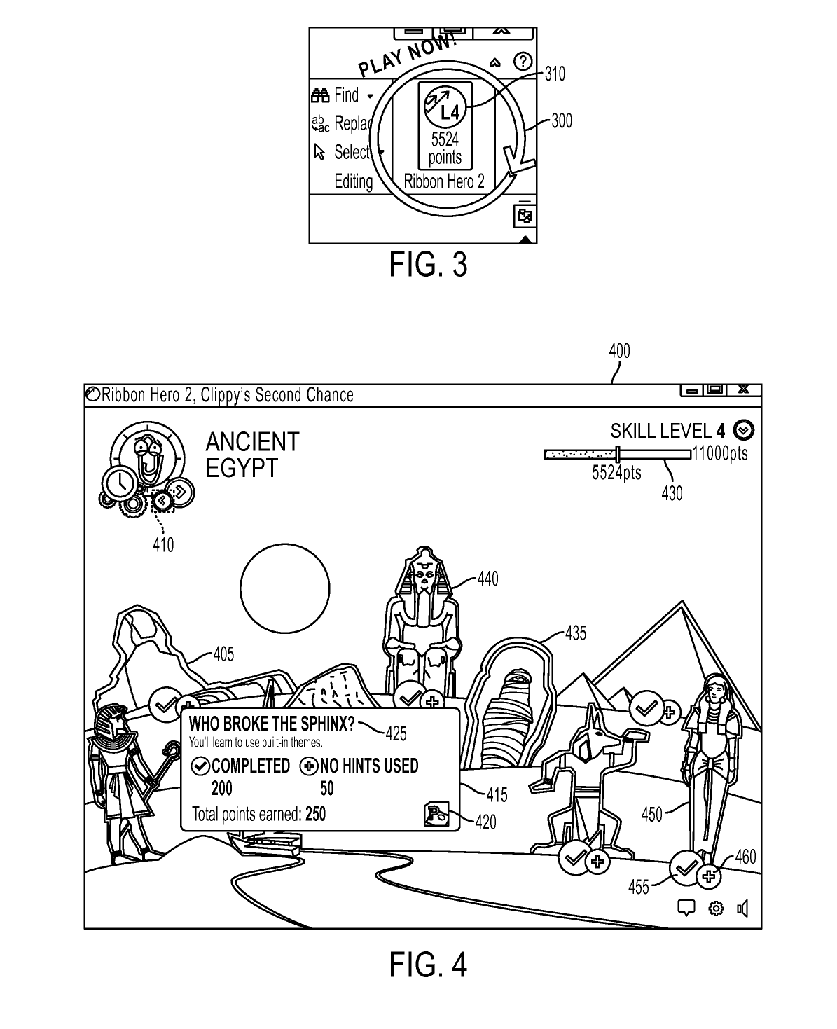

After a start operation 202, the process 200 flows to operation 204, where the game director 26 receives user input re learning tool game launch from a challenge director interface (CDT) within a productivity application 24 that is currently utilized by a user. In an alternative embodiment, the CDI may be actuated as a stand alone application of computing device 100. As will be further explained with reference to animation FIG. 3 and, by way of example, productivity application 24 may be provided with a screen portion within a ribbon, toolbar, dropdown menu or other user interface whereby a learning tool game, herein, Ribbon Hero 2 may be actuated. CDI may locally store skill level and accumulated score for Ribbon Hero 2 in computing device 100 that may be updated when challenge director 26 is accessed. A user may select Ribbon Hero 2 at any time by simply actuating the challenge director 26 by any appropriate selection process known in the art from the actuation portion of the screen, for example, one depicted in FIG. 3.

Moving to operation 206, challenge director 26 determines the learning tool game level and score for a particular user as explained in some detail above and may update FIG. 3 accordingly for the user. In accordance with one aspect and referring briefly to FIG. 3, a CDI of productivity application 24 may be animated and be an attention-getting device whereby, for example, the productivity application screen portion displays, for example, a rotating circle in color and encourages the user to “Play Now.” The animation may play on entry to a productivity application 24, periodically, or when a productivity application 24 is about to shut down. Other events may trigger an animation of FIG. 3. The screen portion need not be animated; however, in accordance with process 206, the screen portion for the CM 200 pay identify the skill level of learning tool game play reached 310 (in this case, level 4) and an accumulated score (in this case, 5524 points). The CDI 300, having identified the user of the productivity application, for example, a word processing application, may receive and display score, level and the like from challenge director 26 if these differ from those stored by CDI 300.

Moving to operation 208, challenge director 26 replaces a display screen of a productivity application 24 with a consolidated game board display according to one of FIG. 4 or FIG. 5, depending on the skill level of game play of the user. In the case of an overall theme of consolidated game play of time travel, a user is transported from a display of a productivity application 24 to an imaginary world. If a user is at level one of learning tool game play, and in keeping, for example, with an overall theme of time travel, a user may be transported to a game board 500 for THE MIDDLE AGES represented by FIG. 5A or other imaginary world represented by FIGS. 5B through 5F. A user is at level two of learning tool game play, and in keeping, for example, with an overall theme of time travel, a user may be transported to a game board 510 for ANCIENT EGYPT represented by FIG. 5B. If a user is at level three of learning tool game play, and in keeping, for example, with an overall theme of time travel, a user may be transported to a game board 520 for THE 1960's represented by FIG. 5C. If a user is at skill level four of learning tool game play, and in keeping, for example, with an overall theme of time travel, a user may be transported to a game board 530 for ANCIENT GREECE represented by FIG. 5D. If a user is at level five of learning tool game play, and in keeping, for example, with an overall theme of time travel, a user may be transported to a game board 540 for THE RENAISSANCE represented by FIG. 5E. If a user is at level six of learning tool game play, and in keeping, for example, with an overall theme of time travel, a user may be transported to a game board 550 for THE FUTURE represented by FIG. 5F. Of course, there may be fewer or more levels than are shown in FIG. 5 for a consolidated learning tool game. There may be a different overall theme than time travel such as space travel (instead of time travel) or other overall theme only limited by the imagination. There may be different score levels for reaching a next skill level of play from a current skill. Following a space travel theme, for example, one may land on the moon, as a first skill level, then, Mars as a second skill level and so on as sub-themes and the number of skill levels and score levels required for reaching a next skill level may vary.

Moving to operation 210, the challenge director 26 receives user input for a selected challenge. In order to receive user input for a selected challenge, the challenge director 26 initially associates a screen image selected by a user by known input methods with a challenge of a particular productivity application. Referring to FIG. 4, there is shown a consolidated game board 400 for ANCIENT EGYPT. At the upper left of the screen, there may be displayed cartoon character, Clippy, in a time machine representation 410, which may be proximate to an ANCIENT EGYPT label. A typical screen image of the consolidated game board display associated with a challenge may be a sphinx 405. An associated challenge may be learning to use built-in themes in a presentation productivity application announced in a banner 415 at position 425. Hovering over the sphinx 405 or otherwise using input/output controller 22, a challenge for the sphinx may be disclosed to the user. In the upper right of game board 400 may be found the skill level of the user at the time, skill level 4, and an indication of an accumulated point total 430 which may be in the form of a graph showing, for example, that 5524 points have been accumulated toward the total needed for the next level of 11,000.

Moving to operation 212, the challenge director 26 launches the selected challenge and associated version of productivity application 24 that is currently available on the user's computing device 100 for, for example, the sphinx image. In one embodiment, the challenge relates to a version of a productivity application 24 currently available and installed on computing device 100. In an alternative embodiment, a challenge and a test version of a productivity application not available at computing device 100 may be downloaded from a remote server 27 and started together. The test version may not be installed on computing device 100 when a challenge is selected; rather, the test productivity application may be started together with the challenge. In either embodiment, the display screen once again takes the form of a productivity application 24 associated with the selected challenge and appears as a portion of the consolidated game board screen 400 or replaces it in total. A work screen from the productivity application may be launched from local computing device 100. If the version of the productivity application 24 associated with the challenge is not available locally, (in this case, a presentation application indicated at 420, for example, by its icon), a test version for the productivity application may be downloaded to computing device 100 under control of challenge director 26 or made available from a network server 27 for remote use to play the challenge as a part of the experience. A test version of the productivity application 24 my be temporarily made available at computing device 100 after a challenge for that productivity application version is selected. The features are not installed on a user's computing device 100. The test version is started with the challenge after the challenge is selected and is limited to actuation as part of the challenge experience. In an alternative embodiment, challenges are launched for versions of productivity applications currently available and installed on a user's computing device 100. In an alternative embodiment, a user may skip a challenge related to a productivity application 24 not available on their computing device 100. An aspect of an embodiment wherein a missing version of a productivity application for play of a challenge may be downloaded under control of a challenge director 26 is that a user may be encouraged to learn or possibly obtain a new version of utilized productivity applications 24 that the user did not have operating on their computing device 100 at the start of the experience. As such, the learning tool game may encourage users to explore additional productivity applications or versions thereof beyond what the user already has installed at the start of using the learning tool game.

Moving to operation 214, the challenge director 26 receives user input for the user's play of the challenge and provides and records usage of hints for challenge play. A user may complete a challenge without using any hints. On the other hand, a user may successfully complete a challenge using hints. It may be more important for a user to successfully learn a feature/command represented by a challenge for a productivity application 24 than for the user to try to complete the challenge unaided by any hints. For example, to complete the challenge, the user may be awarded 200 points while, using no hints, the user may be awarded 50, substantially fewer, bonus points. That is, a bonus may be a small fraction of the total points awarded for completion of a challenge.

Moving to operation 216, the challenge director 26 monitors challenge play, for example, the use of built-in themes in a presentation application associated with the sphinx. The challenge director 26 calculates a score for the played challenge and increments the total score at that level with a calculated score which may comprise a first element for successful completion, e.g., 200 points and a second element for successful completion with as few hints as the user needs to complete the challenge, in this case 50 bonus points for using no hints displayed in banner 415, the total points earned being 250.

Referring further to FIG. 4, there are shown a number of images within an ANCIENT EGYPT consolidated game board, one being a sphinx 405, another being a mummy 435, another being a statue of a pharaoh 440 and another being Cleopatra 450. Underneath the sphinx 405, the pharaoh 440 or Cleopatra 450, for example, are shown an icon or symbol such as a check mark 455 indicating that a user has completed a challenge associated with that image. A further icon or symbol such as plus sign 460 underneath an image may represent a value of bonus points for a challenge associated with an image whereby the user receives bonus points for using as few hints or help as possible in one embodiment or no hints to complete the challenge in another embodiment. In addition to the consolidated game board 400, commands normally provided external to the game board 400 such as minimize (−), shrink and close are shown at the upper right of the screen so that game play may be closed and computing device 100 may return to productivity application 24 or another underlying application currently running. On the other hand, a label may be provided at the upper left of the screen reading: Ribbon Hero 2, Clippy's Second Chance.

A challenge associated with an image of Cleopatra 450 has both been previously selected and completed indicated by the checkmark 455. The plus sign 460 indicates bonus points. A challenge associated with the sphinx 405 has just been played. Both a checkmark for having been selected and a plus sign indicating completion of the challenge with certain bonus points for hint usage (especially, non-usage) are adjacent sphinx 405. There is a banner 415 for the just completed challenge. By way of example, the banner may read “WHO BROKE THE SPHINX, You'll learn to use built-in themes.” Further, in the banner 415, and, for example, associated with a checkmark for completion, one may receive 200 points. Bonus points indicated by the plus sign may be valued at 50 points when no hints are used. As the number of hints used increases, there may be no bonus points awarded. This user has earned 250 points or 200 points for completion plus 50 points for no hints used. Also in the banner 415 is an indication, here, an icon 420 for a Microsoft PowerPoint® presentation productivity application 24 to which the challenge was directed—built-in themes.

Referring again to FIG. 2 and moving to operation 218, there is a decision box shown whereby challenge director 26 determines whether the accumulated score at the game level exceeds a predetermined level for reaching the next level of play. Furthermore, there may be a requirement built into the consolidated game board, for example, FIG. 4, that different commands/features from more than one different productivity application be utilized before moving to the next level of play. If the accumulated game score is not above the score to reach the next skill level of game play, process 200 moves from decision box 218 to box 228. At operation 228, for example, the consolidated game board display 400 of FIG. 4 is updated to show that a challenge, represented by an image portion such as Cleopatra 450 and, most recently, the sphinx 405 has been played. Mummy 435 and its associated challenge appears to have not been played yet. Control of process 200 then returns to operation 208 where the updated consolidated game board for the user's skill level of play is displayed at display 28.

If at decision box 218, the game level score now exceeds a score necessary to move to the next skill level of game play, then, a new consolidated game board may be displayed for the next level. Referring briefly to FIG. 5A, the consolidated game board image 500 for THE MIDDLE AGES may give way to the consolidated game board screen 510 for Ancient Egypt of FIG. 5B. If a score for ANCIENT EGYPT, FIG. 5B of 1700 points is exceeded, then, FIG. 5C with a sub-them of THE 1960's for skill level 3 may be displayed requiring a higher score of 5000 points. If accumulated score total 5000 points is exceeded, then, FIG. 5D for ANCIENT GREECE may be displayed and so on. In accordance with an aspect of the embodiment, an animation or other reward may be provided between levels of game play at operation 220.

Referring briefly to FIG. 5A, there is shown a user interface for a first skill level of game play, for example, representing a sub-theme of the Middle Ages. The depicted user interface 500 for a consolidated game flow learning tool indicates at a given point in time that a user has achieved a score level of for example, 10 points. Since 300 points may be a predetermined level required to move from a first level to a second level, the user interface 500 indicates that the user has not completed the first level of learning tool game play. On the other hand, if the score of 300 points is exceeded by playing a challenge for more than one of the challenges represented by, for example, the depicted tower, the knight, the Canterbury Tales and the like image portions, then, play moves to the next level. The predetermined score level, for example, of 300 points may require the completion of features in one or more of a suite of productivity applications to reach the next level of play. In one embodiment, the predetermined score level may require completion of features in at least two different productivity applications, three productivity applications or all productivity applications of a suite to insure consolidated game flow and usage of all productivity applications of a suite by a user. For example, a predetermined score may require the completion of challenges in each of a word processing, presentation, drawing, and spreadsheet productivity application before moving to the next level of play. A challenge director 26 may control a download of a test version of a productivity application 24 to play a challenge from a network server 27. In this manner and as discussed with respect to operation 212, the user may receive and be encouraged to learn or purchase a new version of a utilized productivity application or a version of a related different productivity application during game play. The selected training challenge may require a download from network 18 or access to a server 27 thereof in order to provide a feature of a different version or a different productivity application 24 not currently available on the user's computing device 100 representing the challenge.

FIG. 5A, in a similar manner and at a similar position on the consolidated game board, may further show an exemplary user interface 500 for a first level of play within a theme of “time travel,” for example, indicated by a symbol such as a time clock shown at the upper left of the game board. The depicted sub-theme for the represented level of play, for example, skill level 1 (shown in a similar location as in FIG. 4) may be the “THE MIDDLE AGES” indicated for example also at the upper left of game board user interface 500. User interface 500 may indicate what challenges have been played and may use theme figures, images, drawings or other depictions to indicate further challenges not yet played.

Within user interface 500 as is shown in FIG. 4 but not in FIG. 5A, checkmarks and plus signs may indicate what challenges have been selected, completed and bonus points awarded. FIGS. 5A-5F show clean game boards with no challenges played and bonus points earned for the images shown. On the other hand. FIG. 5B shows the accumulated score from The Middle Ages as a starting point for achieving a total score of 1700 points needed to reach FIG. 5C, “THE 1960's.” FIG. 5C shows the accumulated total of 1810 from ANCIENT EGYPT to reach THE 1960's and so on. Moving from THE 1960's to ANCIENT GREECE may require 5000 points. ANCIENT GREECE, FIG. 5D, shows that the user has an accumulated score of 5410 on arrival at ANCIENT GREECE. Similarly, THE RENAISSANCE FIG. 5E shows that the user has arrived at skill level 5 with 11410 points exceeding the 11000 points needed to leave skill level 4 and arrive at THE RENAISSANCE. THE FUTURE FIG. 5F shows that the user has arrived at skill level 6 with 26410 points exceeding the 25000 points needed to leave skill level 5 and arrive in THE FUTURE.

Referring again to FIG. 5A, a castle tower may be an image, drawing, figure or the like to indicate a challenge for selection and play. An indication (not shown) of the productivity application utilized for the challenge may also be provided in a banner as in FIG. 4. (“Image” as used herein and in the claims shall mean an image, a drawing, a figure or other depiction of a selectable portion of a consolidated game board user interface.) A person shooting a bow and arrow may indicate a second challenge for selection and play in a different productivity application and so on.

Related features to challenges practiced may pertain to a first productivity application 24-1 or may be relate to more than one productivity application such as changing a font size or selecting a font for text in a word processing productivity application and a presentation productivity application. The feature may be specific to a particular application such as selecting an equation for calculating a particular cell in a spreadsheet productivity application and the like. Further challenges selected, played and won may be shown associated with sub-theme images of FIGS. 4 and 5.

Referring again to FIG. 5A, with the accomplishment of a plurality of challenges including, for example, at least one challenge from more than one productivity application, a score level of 300 points may be indicated within user interface 500 as having been accomplished per operation 220 of FIG. 2. For example, a total score of 312 points just reached may be indicated at an upper right area of a game board in the graph area, showing that the user may advance to the next level.

As briefly explained above, when an indicated score Coca level exceeds the required score for that skill level, then, a reward may follow, starting, for example, the unlocking of a video or a special animation sequence of a reward. The animation sequence may have components associated with mastering a skill level of play and introducing the next skill level of play. For example, the mastering of a level of play may be indicated by an animation comprising arising hot air balloon carrying an animation character, such as Clippy, the paper clip. After the balloon animation sequence, a continue screen may be displayed providing the user with a choice at proceeding to the next level via operation 220. If the user inputs CONTINUE, an animation sequence may show a cartoon or other sequence or video or movie clip showing Clippy having to serve in the army, for example, a part of the overall theme of time travel from THE 1960's when there was a draft to arrive at ANCIENT GREECE. Clippy may thus arrive at a next level of play from a lower skill level to a higher skill level which may represent a different sub-theme to the overall theme of time travel. Other examples of overall theme and related sub-theme may come to mind only limited by the imagination. For example, an overall theme may be space travel. A first level of play may have a related sub-theme of space travel to the moon. A second level of play may have a related sub-theme of space travel to mars. A third level of play may have a related sub-theme of space travel to another galaxy.

Thus, there has been shown and described a consolidated learning tool game flow for a plurality of productivity applications including a computer-implemented process and a user interface among other aspects of consolidating game flow. The above specification, examples and data provide a complete description of the manufacture and use of the composition of the invention. Because many embodiments of the invention can be made without departing from the spirit and scope of the invention, the invention resides in the claims hereinafter appended.

What is claimed:

1. A method for accessing an interactive consolidated learning tool game board from within a productivity application, the method executing on a processor of a computer, comprising:
receiving a first user input at a challenge director interface within one of a first productivity application and a stand alone challenge director interface application for accessing a challenge director;
receiving a second user input of a selected challenge on an interactive consolidated game board display output of the challenge director;
launching the selected challenge and an associated productivity application for playing the selected challenge;
calculating a challenge point award and a total accumulated score according to input received for usage of the launched productivity application; and
comparing the user's total accumulated score to a predetermined score for advancement to a next level of play and, if the predetermined score is exceeded, providing a consolidated game board display for the next level of game play.

2. The method of claim 1, wherein the interactive consolidated game board display output comprises a selectable image representing a challenge and an associated feature of a different second productivity application and a related symbol indicating whether the feature has been utilized by the user as a selected challenge.

3. The method of claim 1, the interactive consolidated game board output comprising a portion for displaying an accumulated user score for completed challenges for features of the first and second productivity applications utilized to date for a given level of play and an indication of the total predetermined score for reaching the next level of play.

4. The method of claim 1, wherein a learning tool game has an overall theme, the user consolidated game board output conforming to a sub-theme, for a skill level of play, of the overall theme for a plurality of interactive consolidated game boards representing a plurality of skill levels of play.

5. The method of claim 1, further comprising displaying a banner portion of the interactive consolidated game board display output for a level of play, the banner for displaying a challenge played of a productivity application and identifying the productivity application associated with the challenge.

6. The method of claim 1, wherein the total score for reaching the next level of play is configured such that skill level of play to reach the next level comprises play of challenges of the first productivity application and of a second different productivity application.

7. The method of claim 1, comprising obtaining one of the challenge director and a version of the productivity application associated with the challenge from a network server.

8. The method of claim 4, comprising representing a challenge of the interactive consolidated game board display output as an interactive image portion conforming to the sub-theme.

9. The method of claim 1, further comprising storing a skill level and an accumulated score in memory associated with the challenge director.

10. The method of claim 8, further comprising updating the stored score according to receiving a third user input of user identity.

11. A computer program product having computer-executable instructions for accessing an interactive consolidated learning tool game board from within a productivity application, the instructions executing on a processor of a computer, comprising:
providing a challenge director interface within one of a first productivity application and a stand alone challenge director interface application for accessing a challenge director;
receiving a first user input of a selected challenge on an interactive consolidated game board display output of the challenge director;
launching the selected challenge and an associated productivity application for playing the selected challenge;
calculating a challenge point award and a total accumulated score according to a second user input received for usage of the launched productivity application; and
comparing the user's total accumulated score to a predetermined score for advancement to a next level of play and, if the predetermined score is exceeded, providing a consolidated game board display for the next level of game play.

12. The computer program product of claim 11 wherein the interactive consolidated game board display output comprises a selectable image representing a challenge for a productivity application and a related symbol configured to indicate whether the challenge has been previously completed by a user.

13. The computer program product of claim 11 wherein the interactive consolidated game board display output comprises a game board portion for displaying an accumulated user score for completing challenges of two different productivity applications utilized to date for a given level of play and an indication of a total predetermined score for reaching a next level of play.

14. The computer program product of claim 11 wherein the interactive consolidated game board display output comprises a banner portion for displaying a challenge played and identifying the productivity application associated with the played challenge.

15. The computer program product of claim 14, the banner portion further comprising an indication of points awarded for the played challenge and bonus points earned.

16. The computer program product of claim 10, wherein the total accumulated score for reaching the next level of play is configured such that a level of play to reach the next level comprises play of challenges of the first productivity application and of a second different productivity application.

16. The computer program product of claim 10 wherein the interactive consolidated game board display output comprises a plurality of game boards having an overall theme, each of the plurality of game boards having a related sub-theme related to the overall theme.

17. A computer-implemented method of encouraging utilization of a plurality of related productivity applications comprising
displaying an interactive consolidated game board on a display of a special purpose computer programmed to receive an input indicating play of a challenge selected from a plurality of available challenges, each challenge represented by a different image portion of the displayed interactive consolidated game board interface, at least two different challenges being related to two different productivity applications; and
launching a productivity application associated with the selected challenge of the two different productivity applications.

18. The computer-implemented method of claim 17 further comprising accumulating a score based on play of challenges of the two different productivity applications of the interactive consolidated game board.

19. The computer-implemented method of claim 17, wherein the interactive consolidated game board has an overall theme and different sub-themes for a plurality of skill levels of play, the learning tool game user interface comprising a selectable image of a sub-theme providing a challenge to learn a feature of a productivity application.

20. The computer-implemented method of claim 19 wherein a symbol appears on the interactive game board proximate the selectable image indicating successful completion of a related challenge.
